(19) United States
(12) Patent Application Publication
(10) Pub. No.: US 2009/0174971 A1
(43) Pub. Date: Jul. 9, 2009

(54) CPP-TYPE MAGNETO RESISTIVE EFFECT ELEMENT HAVING A PAIR OF MAGNETIC LAYERS

(76) Inventors: Yoshihiro Tsuchiya, Tokyo (JP); Shinji Hara, Tokyo (JP); Tomohito Mizuno, Tokyo (JP); Satoshi Miura, Tokyo (JP); Takumi Yanagisawa, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/968,788

(22) Filed: Jan. 3, 2008

(51) Int. Cl. G11B 5/39; G11B 5/127

(52) U.S. Cl. 360/324.2

(57) ABSTRACT

A magnetoresistance effect element comprises: a pair of magnetic layers whose magnetization directions form a relative angle therebetween that is variable depending on an external magnetic field; and a crystalline spacer layer sandwiched between the pair of magnetic layers; wherein sense current may flow in a direction that is perpendicular to a film plane of the pair of magnetic layers and the spacer layer. The spacer layer includes a crystalline oxide, and either or both magnetic layers whose magnetization direction is variable depending on the external magnetic field has a layer configuration in which a CoFeB layer is sandwiched between a CoFe layer and a NiFe layer and is positioned between the spacer layer and the NiFe layer.

### BACKGROUND OF THE INVENTION

1. Field of the Invention

The present invention relates to a CPP (Current-Perpendicular-to-the-Plane) type magnetoresistive effect element in which sense current flows perpendicularly to the film plane, and more particularly, to the structure of a spacer layer and magnetic layers of such a magnetoresistive effect element.

2. Description of the Related Art

CIP-GMR (Current In Plane-Giant Magneto-Resistance) elements in which sense current flows parallel to the element film plane have mainly been used as reproducing elements of thin-film magnetic heads. Recently, efforts have been made to develop elements in which sense current flows perpendicularly to the element film plane in order to cope with higher-density magnetic recording. The elements of this type include a TMR (Tunnel Magneto-Resistance) element utilizing the TMR effect and a CPP-GMR element utilizing the GMR effect.

The TMR element and the CPP-GMR element includes a stack that comprises a magnetic layer (a free layer) whose magnetization direction varies depending on an external magnetic field, a magnetic layer (a pinned layer) whose magnetization direction is fixed with respect to the external magnetic field, and a spacer layer (a nonmagnetic spacer layer) sandwiched between the pinned layer and the free layer. In the TMR element, the spacer layer consists of an insulating layer that is made of Al₂O₃ or the like. Sense current is adapted to flow in a direction that is perpendicular to the film plane of the stack based on the tunneling phenomenon in which electrons pass through the energy barrier of the spacer layer (tunnel barrier layer). In the CPP-GMR element, the spacer layer has a nonmagnetic electrically conductive layer that is made of Cu or the like. In these elements, the relative angle that is formed between the magnetization direction of the free layer and the magnetization direction of the pinned layer varies depending on the external magnetic field, thereby changing the electric resistance to the sense current which flows in the direction that is perpendicular to the film plane of the stack. The external magnetic field is detected based on these properties. Both ends of the stack viewed in the direction of stacking are magnetically shielded by shield layers.

The TMR element is advantageous in that it has theoretically a large electric resistance and provides a large magnetoresistance ratio. The CPP-GMR element, on the other hand, enables a reduction in the cross-sectional area of the element taking advantage of the small electric resistance, and hence is suitable for ultrahigh-density magnetic recording.

Developments have been made to further increase the magnetoresistance ratio of the above elements. US patent application publication No. 2006/0012926 discloses a spacer that is made of MgO in place of AlOx (Al₂O₃ or the like) which has typically been used as a material of the spacer layer of the TMR element. Semiconductor material has been studied as a material of the spacer layer of the CPP-GMR element. Japanese patent application publication No. 2003-8102 discloses a layer configuration that comprises a ZnO layer disposed between a free layer and a pinned layer together with a conventional spacer layer. The semiconductor layer, which has a large resistance, is used as a layer to adjust the electric resistance of the element to an appropriate value.

Recently, novel layer configurations which are completely different from the conventional layer configurations that include the free layer and the pinned layer have been proposed. “Current-in-Plane GMR Trilayer Head Design for Hard-Disk Drives” (IEEE TRANSACTIONS ON MAGNETICS, Volume 43, Number 2, February, 2007) discloses a stack for use in a CIP element that comprises two magnetic layers whose magnetization directions are variable depending on an external magnetic field and a spacer layer sandwiched between the magnetic layers. A bias magnetic layer is disposed on the back side of the stack viewed from an air bearing surface thereof, and applies a bias magnetic field in a direction that is perpendicular to the air bearing surface. The magnetization directions of the two magnetic layers form a certain relative angle therebetween under a magnetic field applied from the bias magnetic layer. When an external magnetic field is applied in this state, the magnetization directions of the two magnetic layers are varied, the relative angle formed between the magnetization directions of the two magnetic layers is thereby changed, and accordingly, the electric resistance to the sense current is changed. It is possible to detect the external magnetization based on these properties. U.S. Pat. No. 7,035,062 discloses an example in which such a layer configuration is applied to a CPP element. In this way, the layer configuration that uses two magnetic layers has a simple layer configuration, and has the potential for reducing the shield gap because it does not require a conventional synthetic pinned layer and an antiferromagnetic layer.

However, in order to achieve a large magnetic sensitivity, it is necessary for a magnetic layer whose magnetization direction is variable depending on an external magnetic field to be provided with good soft magnetic characteristics. The conventional art referred to above is advantageous in that it is capable of increasing the magnetoresistance ratio, but is disadvantageous in that it degrades the soft magnetic characteristics. The soft magnetic characteristics are represented by the coercivity and magnetostriction of the magnetic layer whose magnetization direction is variable depending on the external magnetic field. It is desirable to make the coercivity as small as possible and to make the absolute value of the magnetostriction as small as possible. A target value of the coercivity is about 800 A/m or less (100 Oe or less). The magnetostriction should desirably be in a range up to +5×10⁻⁶ inclusive. The lower limit of the target of the magnetostriction is −10×10⁻⁶, which, however, is merely a rough target because the magnetostriction can be adjusted by adjusting the composition and film thickness of a NiFe layer in the magnetic layer. FIG. 1A shows an example of coercivity of a spacer layer made of AlOx and a spacer layer made of MgO used for the TMR element. The free layer has a layer configuration of 30Co70Fe (film thickness x nm)/90Ni10Fe (film thickness of 4 nm), and film thickness x of the 30Co70Fe layer is varied. In the present specification, the notation A/B/C . . . indicates that layer A, layer B, and layer C are stacked in this order. The coercivity in the case of AlOx is larger than that in the case of MgO in the region where the film thickness is large, but the latter is larger than the former in the other region. In order to reduce the coercivity, it is necessary to reduce the film thickness of the CoFe layer. However, a reduction in the film thickness of the CoFe layer leads to a reduction in the magnetoresistance ratio, cancelling the merit of MgO, because the CoFe layer contributes to a change in the magnetoresistance. FIG. 1B shows an example of magnetostriction measured under the same conditions as in FIG. 1A. The absolute value of the magnetostriction tends to increase as compared with the case of AlOx, particularly in a region where the film thickness of the CoFe layer is small.

### SUMMARY OF THE INVENTION

It is an object of the present invention to provide a magnetoresistance effect element which is capable of achieving a high magnetoresistance ratio while ensuring soft magnetic characteristics of a magnetic layer whose magnetization direction is variable depending on an external magnetic field (hereinafter also referred to as “variable magnetization direction magnetic layer”). Another object of the present invention is to provide a slider, a hard disk drive, etc. incorporating such a magnetoresistance effect element.

According to an embodiment of the present invention, a magnetoresistance effect element comprises: a pair of magnetic layers whose magnetization directions form a relative angle therebetween that is variable depending on an external magnetic field; and a crystalline spacer layer sandwiched between the pair of magnetic layers; wherein sense current may flow in a direction that is perpendicular to a film plane of the pair of magnetic layers and the spacer layer. The spacer layer includes a crystalline oxide, and either or both magnetic layers whose magnetization direction is variable depending on the external magnetic field has a layer configuration in which a CoFeB layer is sandwiched between a CoFe layer and a NiFe layer and is positioned between the spacer layer and the NiFe layer.

The spacer layer, as well as the CoFe layer and the NiFe layer which constitute the variable magnetization direction magnetic layer, have a crystalline structure. If layers having a crystalline structure are arranged adjacent to each other, and lattice constants thereof match each other, then good film characteristics are obtained. If there is a mismatch in the lattice constant, then the crystalline structure is disturbed at the interface between the adjacent layers, making it difficult to obtain good film characteristics. If three or more crystalline layers are stacked, then one of the layers may be affected by another crystalline layer that is not directly adjacent to the layer, possibly disturbing the crystalline structure. Since a crystalline oxide has a particularly large lattice constant, a large mismatch in the lattice constant is caused between the crystalline oxide and another crystalline layer, as compared with the case in which a conventional spacer layer made of a single Cu layer is used. The inventors of the present invention think that this affects the soft magnetic characteristics of the variable magnetization direction magnetic layer. According to the present invention, the CoFeB layer is inserted between the CoFe layer and the NiFe layer of the variable magnetization direction magnetic layer. Since CoFeB has an amorphous structure, it has a function to mitigate the influence which the crystalline layers disposed on both sides of the CoFeB layer may exert on each other. Therefore, even if an oxide layer having a mismatch in the lattice constant is used as the spacer layer, the CoFeB layer function as a buffer layer, changing the magnetostriction of the NiFe layer at is the interface. It is thought that this results in the NiFe layer having good film properties, and accordingly, in the NiFe layer having good soft magnetic characteristics. Conversely, it is also possible that the NiFe layer affects the CoFe layer. However, this influence can also be mitigated by the CoFeB layer. As a result, the film properties of the CoFe layer are improved, and an increase in the magnetoresistance ratio can be obtained.

The pair of magnetic layers may comprise a pinned layer whose magnetization direction is fixed with respect to the external magnetic field, and a free layer whose magnetization direction is variable depending on the external magnetic field.

The spacer layer may have a layer configuration in which a ZnO layer is interposed between Cu layers, or may have a layer configuration in which a ZnO layer is sandwiched between a Cu layer and a Zn layer. The spacer layer may include an MgO layer.

A slider according to the present invention comprises a magnetoresistance effect element mentioned above.

A thin-film magnetic head according to the present invention includes a magnetoresistance effect element mentioned above.

A wafer according to the present invention includes a magnetoresistance effect element mentioned above formed therein.

A head gimbal assembly according to the present invention comprises a slider mentioned above, and a suspension resiliently supporting the slider.

A hard disk drive according to the present invention comprises a slider mentioned above, an element for supporting the slider and for positioning the slider with respect to a recording medium.

As described above, according to the present invention, it is possible to provide a magnetoresistance effect element which is capable of achieving a high magnetoresistance ratio while ensuring soft magnetic characteristics of a magnetic layer whose magnetization direction is variable depending on an external magnetic field. Furthermore, according to the present invention, it is possible to provide a slider, a hard disk drive, etc. incorporating such a magnetoresistance effect element.

The above and other objects, features and advantages of the present invention will become apparent from the following description with reference to the accompanying drawings which illustrate examples of the present invention.

### BRIEF DESCRIPTION OF THE DRAWINGS

FIG. 1A is a graph showing an example of the coercivity of a spacer layer made of AlOx and the coercivity of a spacer layer made of MgO used for the TMR element;

FIG. 1B is a graph showing an example of magnetostriction measured under the same conditions as in FIG. 1A;

FIG. 2 is a partial perspective view of a thin-film magnetic head according to the present invention;

FIG. 3 is a side elevational view of a stack included in the thin-film magnetic head shown in FIG. 2;

FIG. 4A is a graph showing the relationship between the film thickness of the CoFeB layer and the coercivity, the magnetostriction and the improvement ratio of the magnetoresistance ratio in the first embodiment;

FIG. 4B is a graph showing the relationship between the concentration of B (atomic percent) of the CoFeB layer and the coercivity, the magnetostriction and the improvement ratio of the magnetoresistance ratio in the first embodiment;

FIGS. 5A through 5C are graphs showing the coercivity, the magnetostriction and the improvement ratio of the magnetoresistance ratio, respectively, in the layer configurations of Cu/ZnO/Cu and Cu/ZnO/Zn in the second embodiment;

FIG. 6 is a graph showing the relationship between the concentration (atomic percent) of Co in the CoFeB layer and the coercivity, the magnetostriction and the magnetoresistance ratio in the second embodiment;

FIG. 7 is a graph showing the relationship between the film thickness of the CoFeB layer and the coercivity, the magnetostriction and the improvement ratio of the magnetoresistance ratio in the third embodiment;

FIGS. 8A and 8B are graphs showing the relationship between the coercivity and the film thickness of the CoFe layer and the relationship between the magnetostriction and the film thickness of the CoFe layer, respectively, in the third embodiment;

FIG. 9 is a graph showing the relationship between the concentration (atomic percent) of Co in the CoFeB layer and the coercivity, the magnetostriction and improvement ratio of the magnetoresistance ratio in the third embodiment;

FIG. 10 is a plan view of a wafer having the magnetic field detecting elements of the present invention formed therein;

FIG. 11 is a perspective view of a slider of the present invention;

FIG. 12 is a perspective view of a head arm assembly which includes a head gimbal assembly which incorporates a slider of the present invention;

FIG. 13 is a side view of a head arm assembly which incorporates sliders of the present invention; and

FIG. 14 is a plan view of a hard disk drive which incorporates sliders of the present invention.

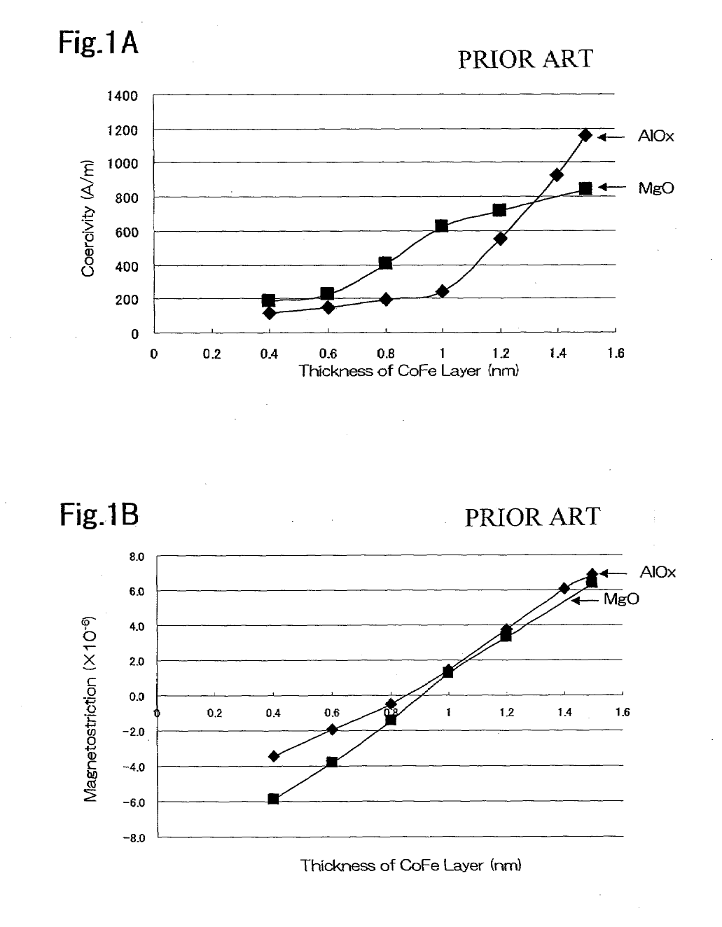

### DESCRIPTION OF THE PREFERRED EMBODIMENTS

Embodiments in which a magnetoresistance effect element according to the present invention is applied to a thin-film magnetic head for use in a hard disk drive will be described below with reference to the drawings. The magnetoresistance effect element according to the present invention is also applicable to a magnetic memory element, a magnetic sensor assembly, or the like.

### 1st Embodiment

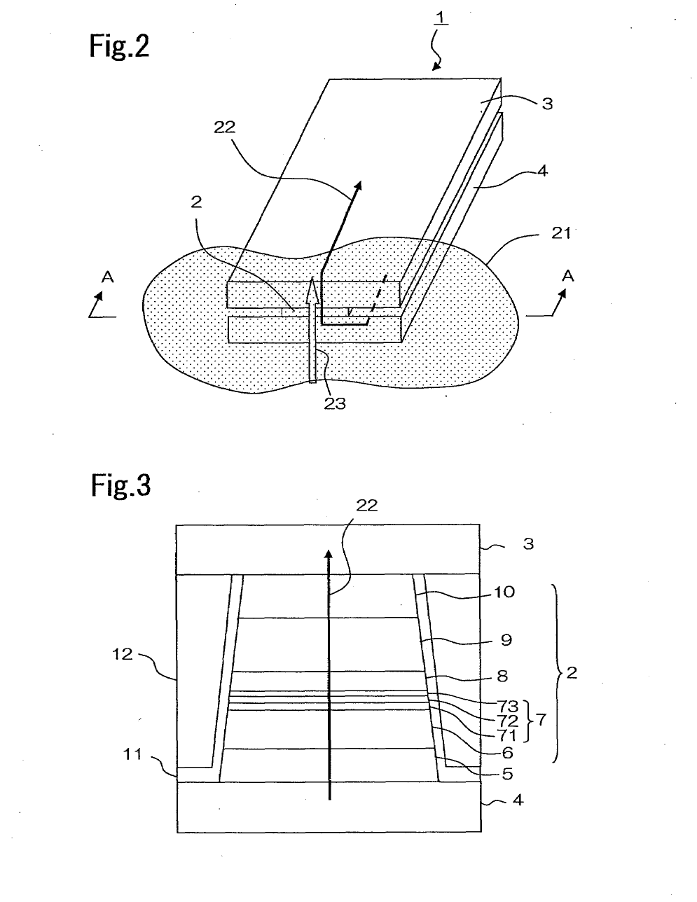

A magnetoresistance effect element according to the present embodiment is used as a magnetoresistance effect element in a CPP-GMR element. FIG. 2 is a partial perspective view of a thin-film magnetic head that includes magnetoresistance effect element 2 according to the present invention. Thin-film magnetic head 1 may be a read-only head or may be an MR/inductive composite head having a write head portion. Magnetoresistance effect element 2 is arranged between upper electrode shield 3 and lower electrode shield 4 and has a tip end that faces recording medium 21. Magnetoresistance effect element 2 is adapted to allow sense current 23 to flow in a direction that is perpendicular to the film plane under a voltage that is applied between upper electrode shield 3 and lower electrode shield 4. The magnetic field of recording medium 21 at a position that faces magnetoresistance effect element 2 changes in accordance with the movement of recording medium 21 in moving direction 23. Thin-film magnetic head 1 detects a change in magnetic field as a change in electric resistance based on the GMR effect, and thereby reads magnetic information written in recording medium 21.

FIG. 3 is a side elevational view of a stack as viewed in the A-A direction shown in FIG. 2, i.e., as viewed from an air bearing surface. The air bearing surface refers to the surface of thin-film magnetic head 1 which faces recording medium 21. Table 1 shows an example of the layer configuration of magnetoresistance effect element 2. In the table, the layers are shown in the order of stacking, from buffer layer 5 in the bottom row, which is adjacent to lower shield electrode layer 4, toward cap layer 10 in the top row, which is adjacent to upper shield electrode layer 3.

TABLE 1

| Layer Configuration | | Composition | Thickness(nm) |
|---|---|---|---|
| Cap Layer 10 | | Ru | 10 |
| Free Layer 9 | | NiFe | 5 |
| | | CoFeB | 0.5 |
| | | CoFe | 1 |
| Spacer Layer 8 | | Cu | 0.7 |
| | | ZnO | 1.6 |
| | | Cu | 0.7 |
| Pinned Layer 7 | Inner Pinned Layer 73 | CoFe | 3 |
| | Intermediate Layer 72 | Ru | 0.8 |
| | Outer Pinned Layer 71 | CoFe | 3 |

| | | |
|---|---|---|
| Antiferromagnetic Layer 6 | IrMn | 5 |
| Buffer Layer 5 | Ru | 2 |
| | Ta | 1 |

Magnetoresistance effect element 2 has a layer configuration comprising buffer layer 5, antiferromagnetic layer 6, pinned layer 7, nonmagnetic spacer layer 8, free layer 9, and cap layer 10 stacked in this order on lower electrode shield 4, which is made of a NiFe layer having a thickness of about 1 μm. Pinned layer 7 is a layer whose magnetization direction is fixed with respect to an external magnetic field. Free layer 9 is a layer whose magnetization direction is variable depending on the external magnetic field (a variable magnetization direction magnetic layer). Sense current 22 is adapted to flow through pinned layer 7, nonmagnetic spacer layer 8, and free layer 9, i.e., in a direction that is perpendicular to the film plane of magnetoresistance effect element 2. The “direction that is perpendicular to the film plane” includes the direction of sense current 22 that is strictly perpendicular to the film plane, as well as a direction that is substantially perpendicular to the film plane. The magnetization direction of free layer 9 forms a relative angle with respect to the magnetization direction of pinned layer 7 depending on the external magnetic field. The spin-dependent scattering of conduction electrons changes depending on the relative angle, causing a change in the magnetoresistance. Thin-film magnetic head 1 detects the change in the magnetoresistance in order to read magnetic information in the recording medium.

Pinned layer 7 is constructed as a so-called synthetic pinned layer. Specifically, pinned layer 7 consists of outer pinned layer 71, inner pinned layer 73 disposed more closely to spacer layer 8 than outer pinned layer 71, and nonmagnetic intermediate layer 72 sandwiched between outer pinned layer 71 and inner pinned layer 73. The magnetization direction of outer pinned layer 71 is fixed based on the exchange coupling between antiferromagnetic layer 6 and outer pinned layer 71. Inner pinned layer 73 is antiferromagnetically coupled to outer pinned layer 71 via intermediate layer 72, and the magnetization direction thereof is firmly fixed. In the pinned layer, a stable magnetization state is ensured in this way, and effective magnetization is limited as a whole.

Spacer layer 8 has a structure of Cu/ZnO/Cu. The ZnO layer is a crystalline semiconductor layer. The Cu layer also has a crystalline structure. Conventionally, a single Cu layer has been used as the spacer layer. However, the electric resistance of spacer layer 8 can be increased by inserting the ZnO layer. In the CPP-GMR element, an increase in the magnetoresistance ratio has been a problem because of the generally small electric resistance. It is possible to achieve a large magnetoresistance ratio by utilizing spacer layer 8 having the structure of Cu/ZnO/Cu.

Free layer 9 has a structure of CoFe/CoFeB/NiFe. The CoFe layer has large spin polarizability and mainly contributes to an increase in the magnetoresistance ratio. The atomic percent of Co, preferable for achieving satisfactory spin polarizability, ranges between 20 and 70%. The NiFe layer is a soft magnetic layer, which serves to limit magnetostriction and has a function to increase the sensitivity to a change in the magnetic field based on the limited coercivity. The atomic percent of Ni is preferably in the range between 75 and 95%, which enables satisfactory soft magnetic characteristics (low coercivity and low magnetostriction). The CoFeB layer is an amorphous layer that is inserted between the CoFe layer and the NiFe layer.

Buffer layer 5 is provided in order to obtain good exchange coupling between antiferromagnetic layer 6 and outer pinned layer 71. Cap layer 10 is provided in order to prevent the stacked layers from deteriorating. Upper electrode shield 3, which consists of a NiFe film having a thickness of about 1 μm, is disposed over cap layer 10.

On both sides of magnetoresistance effect element 2, hard bias films 12 are disposed via insulating films 11 and seed layers made of Cr, CrTi, or the like, not shown. Hard bias films 12 are magnetic domain control films to magnetize free layer 9 into a single magnetic domain. Insulating films 11 are made of Al₂O₃, and hard bias films 12 are made of CoPt, CoCrPt, or the like.

The present embodiment is characterized by spacer layer 8 having the structure of Cu/ZnO/Cu, as well as free layer 9 having the structure of CoFe/CoFeB/NiFe. Each layer (Cu/ZnO/Cu) that constitutes spacer layer 8, as well as the CoFe layer and the NiFe layer that constitutes free layer 9, has a crystalline structure. If there is a mismatch in the lattice constant between adjacent layers having crystalline structures, then the crystalline structure is disturbed at the interface between the adjacent layers, making it difficult to obtain good film characteristics. Disturbance of the crystalline structure prevents the layer from exhibiting its inherent characteristics, and if the layer is made of NiFe, then the soft magnetic characteristics are degraded. If three or more crystalline layers are stacked, then one layer may also be affected by another crystalline layer that is not directly adjacent to the layer, possibly disturbing the crystalline structure. Since the ZnO layer, which is used as part of spacer layer 8, is an oxide, it has a particularly large lattice constant, and it causes a large mismatch in the lattice constant between the ZnO layer and another crystalline layer, as compared with a case in which a conventional spacer layer made of a single Cu layer is used. The inventors of the present invention think that this affects the soft magnetic characteristics of free layer 9. According to the present embodiment, the CoFeB layer is inserted between the CoFe layer and the NiFe layer of free layer 9. CoFeB, which has an amorphous structure, has a function to limit the effect that the ZnO layer may exert on the NiFe layer. Therefore, even if the ZnO layer is used as part of spacer layer 8, the CoFeB layer functions as a buffer layer so that good film characteristics of the NiFe layer, and accordingly, good soft magnetic characteristics are obtained.

If there is a mismatch in the lattice constants, then there is not only the possibility that a layer that is stacked first disturbs the crystalline structure of a layer that is stacked afterwards, but also the possibility that a layer that is stacked afterwards disturbs the crystalline structure of a layer that is stacked first. Therefore, the NiFe layer may affect the CoFe layer. However, the effect is also reduced by the CoFeB layer. As a result, the film characteristics of the CoFe layer are improved, and the magnetoresistance ratio is increased.

As described above, since there is the possibility that the crystalline structure of a layer that is stacked first is disturbed by a layer that is stacked afterwards, the present invention is applicable not only to a bottom-type CPP-GMR element, in which the pinned layer is deposited prior to the free layer, but also to a top-type CPP-GMR element, in which the free layer is deposited prior to the pinned layer. In the latter case, the free layer preferably has a layer configuration of NiFe/CoFeB/CoFe because the CoFeB layer needs to be disposed between the NiFe layer and the ZnO layer. The pinned layer does not need to be a synthetic pinned layer, and may have a single layer configuration without utilizing the antiferromagnetic coupling.

Next, elements having the layer configuration shown in Table 1 were fabricated to determine an appropriate film thickness of the CoFeB layer in the free layer on an experimental basis. The junction size of the elements was set to 0.2 μm×0.2 μm, the annealing temperature was set to 270 degrees, and the concentration (atomic percent) of B in the CoFeB layer was set to 18%. The RA value of all the elements is within the range from 0.1 to 0.25 (Ω·μm²). RA represents the product of electric resistance R of the stack to the sense current and minimum cross-sectional area A of the stack measured in the film plane. If the CPP-GMR element is applied to a magnetic head, then RA should preferably be 0.35 (Ω·μm²) or less because an increase in RA leads to an increases in noise and to a significant decrease in the S/N ratio.

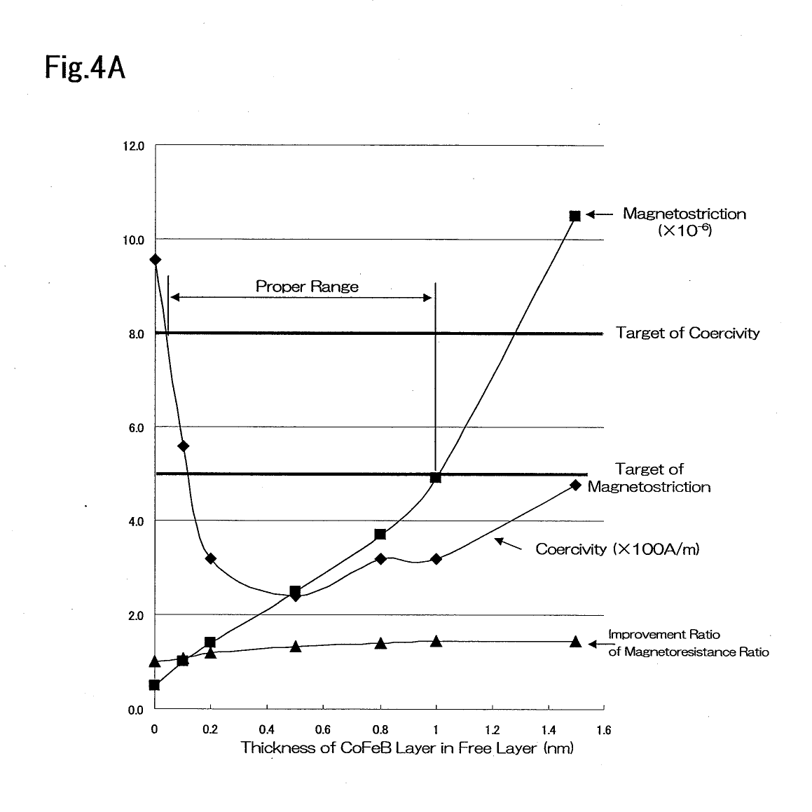

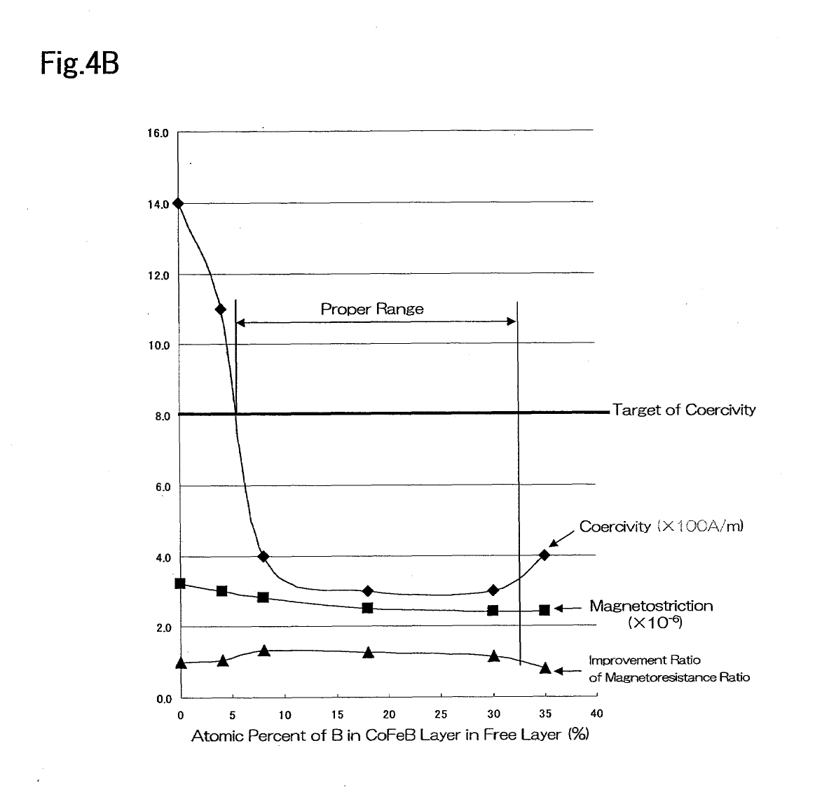

FIG. 4A shows the coercivity, the magnetostriction and the improvement ratio of the magnetoresistance ratio when the film thickness of the CoFeB layer in the free layer is varied from 0 nm to 1.5 nm. The improvement ratio of the magnetoresistance ratio is a value that is normalized by the magnetoresistance ratio in the case in which the film thickness of the CoFeB layer is nil, i.e., the case in which the free layer has the conventional configuration of CoFe/NiFe. In the following study, a target for the coercivity is set to about 800 A/m or less (100 Oe or less), a target for the magnetostriction is set to +5×10⁻⁶ or less, and a target for improvement ratio of the magnetoresistance ratio is set to 1 or more. If the magnetostriction is minus, then the target value is −10×10⁻⁶ or more. However, since the magnetostriction can be adjusted by adjusting the composition of NiFe (increasing Fe) or by adjusting the film thickness of the NiFe layer (reducing the film thickness), the above value is merely a rough target. In accordance with an increase in the film thickness of the CoFeB layer, the magnetoresistance ratio gradually increases, but the magnetostriction also increases. In accordance with an increase in the film thickness of the CoFeB layer, the coercivity decreases first and then increases until it finally exceeds the target value. The film thickness of the CoFeB layer that satisfies the above criteria generally ranges from 0.1 nm to 1 nm.

Next, elements having the layer configuration shown in Table 1 were fabricated to determine an appropriate concentration (atomic percent) of B in the CoFeB layer in the free layer on an experimental basis. The junction size of the elements was set to 0.2 μm×0.2 μm, the annealing temperature was set to 270 degrees and the film thickness of the CoFeB layer was set to 0.5 nm. FIG. 4B shows the coercivity, the magnetostriction and the improvement ratio of the magnetoresistance ratio when the concentration (atomic percent) of B in the CoFeB layer in the free layer is varied from 0% to 35%. The improvement ratio of the magnetoresistance ratio is a value that is normalized by the magnetoresistance ratio in the case in which the film thickness of the CoFeB layer is nil, i.e., the case in which the free layer has the conventional configuration of CoFe/NiFe. In accordance with an increase in the concentration of B, the coercivity sharply decreases. However, in the larger concentration range of B, the coercivity and the magnetostriction do not exhibit large variation, although the improvement ratio of the magnetoresistance ratio falls below 1 when the concentration of B is more than 30%. The concentration of B in the CoFeB layer which satisfies the above criteria generally ranges from 6% to 31%.

The magnetoresistance effect element described above is manufactured as described below. First, lower electrode shield 4 is formed on a substrate, not shown, made of ceramic material, such as ALTIC (Al₂O₃.TiC), via an insulating layer, not shown. Then, the layers starting with buffer layer 5 and ending with cap layer 10 are successively deposited by means of sputtering. When a top-type CPP element is produced, the free layer is formed first. Spacer layer 8 is deposited in the order of the Cu layer, the ZnO layer and the Cu layer in accordance with the layer configuration. The ZnO layer may also be formed by depositing a Zn layer first and then by oxidizing it. The multilayer stack thus deposited is formed into a column shape by patterning, thereby completing magnetoresistance effect element 2. Thereafter, hard bias films 12 are disposed on both sides of magnetoresistance effect element 2, and an insulating layer is formed in the remaining regions. Consequently, as shown in FIG. 2, upper electrode shield 3 is formed, completing the read head portion of the thin-film magnetic head. If a write head portion is provided, then a write magnetic pole layer and a coil are stacked, and the overall films are covered with a protective film. Then, dicing of the wafer, lapping, and separation into slider are performed.

### 2nd Embodiment

A second embodiment of the present invention will be described below. A magnetoresistance effect element according to the second embodiment is similar to the first embodiment except that the layer configuration Cu/ZnO/Cu of the spacer layer according to the first embodiment is changed to Cu/ZnO/Zn. Table 2 shows an example of the layer configuration of the stack according to the present embodiment. Similarly to the first embodiment, the present embodiment is used as a magnetoresistance effect element in a CPP-GMR element.

TABLE 2

| Layer Configuration | | Composition | Thickness(nm) |
|---|---|---|---|
| Cap Layer 10 | | Ru | 10 |
| Free Layer 9 | | NiFe | 5 |
| | | CoFeB | 0.5 |
| | | CoFe | 1 |
| Spacer Layer 8 | | Zn | 0.7 |
| | | ZnO | 1.6 |
| | | Cu | 0.7 |
| Pinned Layer 7 | Inner Pinned Layer 73 | CoFe | 3 |
| | Intermediate Layer 72 | Ru | 0.8 |
| | Outer Pinned Layer 71 | CoFe | 3 |

| | | |
|---|---|---|
| Antiferromagnetic Layer 6 | IrMn | 5 |
| Buffer Layer 5 | Ru | 2 |
| | Ta | 1 |

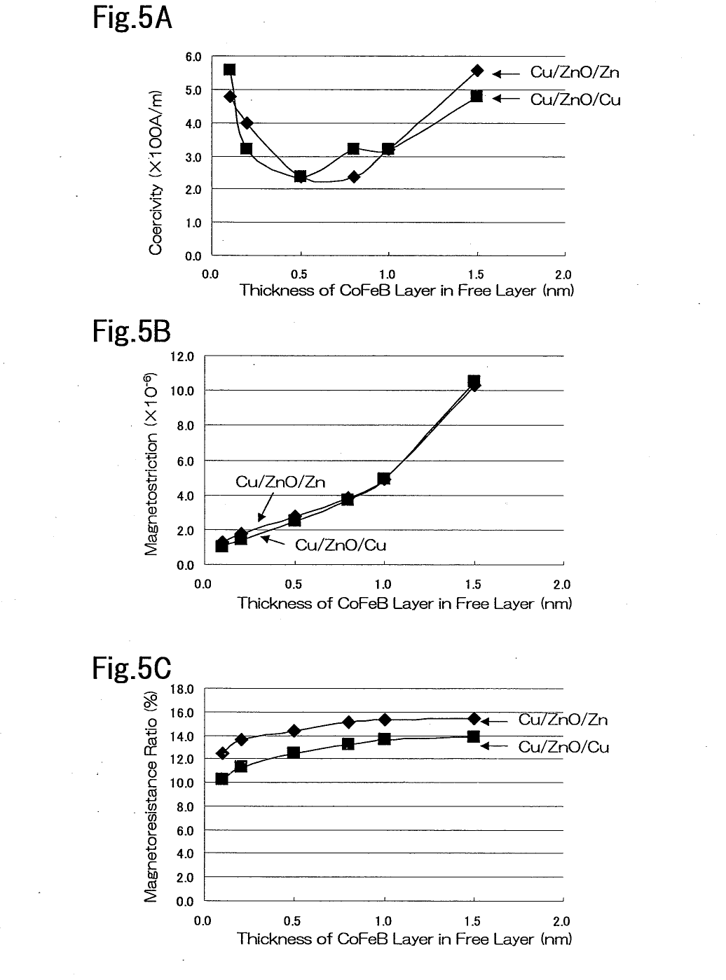

FIGS. 5A through 5C show the comparison of coercivity, the magnetostriction and the magnetoresistance ratio between a layer configuration of Cu/ZnO/Cu and a layer configuration of Cu/ZnO/Zn. Conditions on the experiment are the same as in the first embodiment. Similarly to the case of Cu/ZnO/Cu, satisfactory results were obtained regarging the coercivity, the magnetostriction and the magnetoresistance ratio. In particular, the magnetoresistance ratio obtained is larger than the value obtained for the layer configuration of Cu/ZnO/Cu.

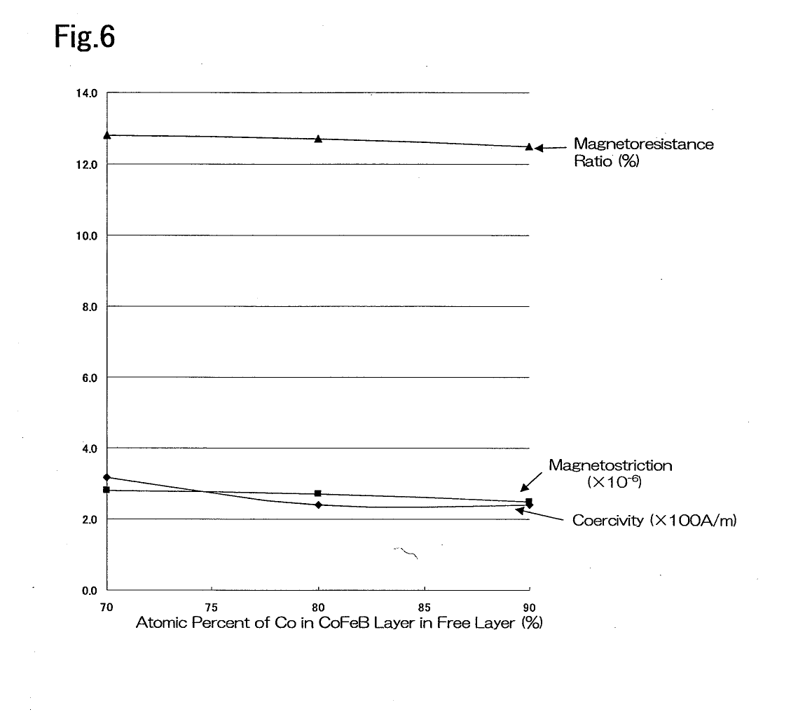

FIG. 6 shows the coercivity, the magnetostriction and the magnetoresistance ratio when the concentration (atomic percent) of Co in the CoFeB layer in the free layer was varied. The film thickness of the CoFeB layer was set to 0.5 nm. Specifically, the concentrations of B and CoFe in the CoFeB layer were fixed at 18% and at 82%, respectively, and the concentration of Co in CoFe was treated as a parameter. The concentration of Co is defined as the atomic percent of Co in CoFe. The coercivity, the magnetostriction and the magnetoresistance ratio do not exhibit large variation in the range of the concentration of Co between 70% and 90%, and it was found that constant and satisfactory results were obtained in the above range.

As an alternative layer configuration of the spacer layer other than the above embodiment, an SnO layer may be used instead of the ZnO layer. The ZnO layer and the SnO layer may be sandwiched between Cu layers or between a Cu layer and a Zn layer on both sides. The spacer layer may also consist of a single layer.

### 3rd Embodiment

A third embodiment of the present invention will be described below. A magnetoresistance effect element according to the third embodiment is similar to the first embodiment except that the layer configuration Cu/ZnO/Cu of the spacer layer according to the first embodiment is changed to MgO. Table 3 shows an example of the layer configuration of the stack according to the present embodiment. The present embodiment is used as a magnetoresistance effect element in a TMR element.

TABLE 3

| Layer Configuration | | Composition | Thickness(nm) |
|---|---|---|---|
| Cap Layer 10 | | Ru | 10 |
| Free Layer 9 | | NiFe | 4 |
| | | CoFeB | 0.4 |
| | | CoFe | 0.6 |
| Spacer Layer 8 | | MgO | 1 |
| Pinned Layer 7 | Inner Pinned Layer 73 | CoFe | 1 |
| | | CoFeB | 1.8 |
| | Intermediate Layer 72 | Ru | 0.8 |
| | Outer Pinned Layer 71 | CoFe | 3 |

| | | |
|---|---|---|
| Antiferromagnetic Layer 6 | IrMn | 7 |
| Buffer Layer 5 | Ru | 2 |
| | Ta | 1 |

MgO has a crystalline structure, similarly to Cu/ZnO/Cu, and is more apt to affect the soft magnetic characteristics of the free layer than AlOx that has an amorphous structure that has been conventionally used. However, for the same reasons as described above, the CoFeB layer works as a buffer layer to mitigate the effect that spacer layer 8 exerts on the free layer, enabling the formation of a NiFe layer having satisfactory characteristics. Similarly, the effect that the NiFe layer exerts on the CoFe layer is reduced, enabling the formation of a CoFe layer having satisfactory characteristics. Therefore, it is possible to provide a TMR element with improvement both in the soft magnetic characteristics and in the magnetoresistance ratio.

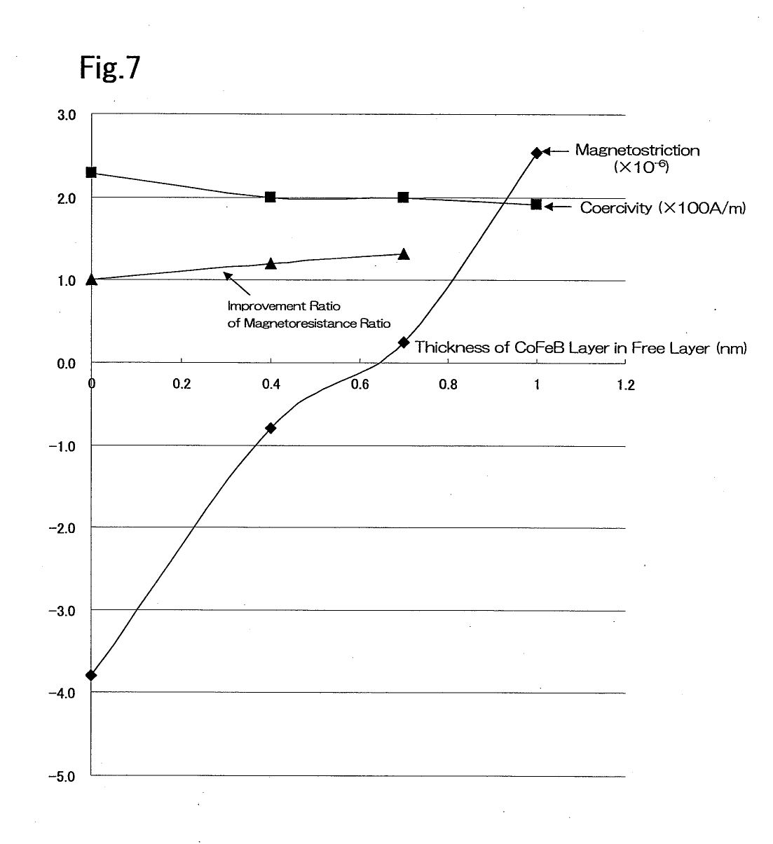

Elements having the layer configuration shown in Table 3 were fabricated to determine an appropriate film thickness of the CoFeB layer in the free layer on an experimental basis. The annealing temperature was set to 250 degrees, and the film thickness of the CoFe layer was set to 0.6 nm. FIG. 7 shows the coercivity, the magnetostriction and improvement ratio of the magnetoresistance ratio when the film thickness of the CoFeB layer in the free layer was varied from 0 nm to 1 nm. The improvement ratio of the magnetoresistance ratio is a value that is normalized by the magnetoresistance ratio in the case in which the film thickness of the CoFeB layer is nil, i.e., the case in which the free layer has the conventional configuration of CoFe/NiFe. As with the first and second embodiments, the target value for the coercivity is set to about 800 A/m or less (100 Oe or less). A target value for the magnetostriction is set to +5×10⁻⁶ or less. A target value for the improvement ratio of the magnetoresistance ratio is set to 1 or more. In accordance with an increase in the film thickness of the CoFeB layer, the magnetoresistance ratio gradually increases, while the coercivity decreases. Also, in accordance with an increase in the film thickness of the CoFeB layer, the magnetostriction changes from negative values to positive values, and monotonously increases while keeping positive values. The above criteria are satisfied within the range of the film thickness of the CoFeB layer up to 1 nm inclusive. The film thickness of the CoFeB layer in the free layer should preferably range from 0.1 nm to 1 nm, taking into consideration film-depositing characteristics.

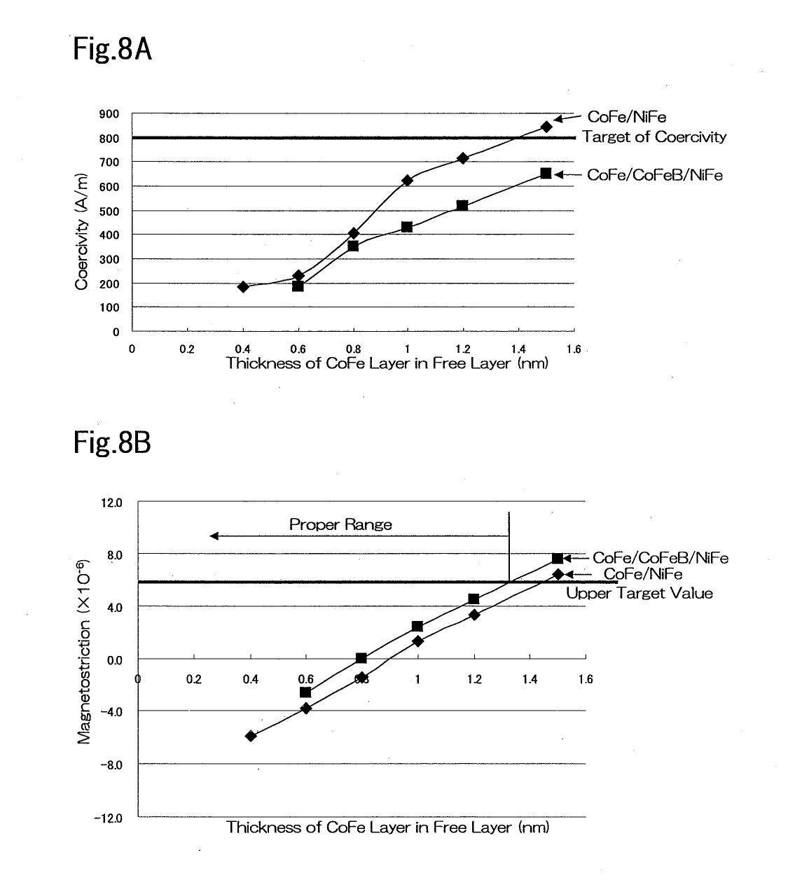

Next, elements having the layer configuration shown in Table 3 were fabricated to determine an appropriate film thickness of the CoFe layer in the free layer on an experimental basis. The annealing temperature was set to 250 degrees, and the film thickness of the CoFeB layer was set to 0.4 nm. FIG. 8A shows the coercivity when the film thickness of the CoFe layer was varied from 0.6 nm to 1.5 nm. FIG. 8B shows the magnetostriction when the film thickness of the CoFe layer was varied from 0.6 nm to 1.5 nm. FIGS. 8A and 8B also show the results obtained for the free layer that is made of CoFe/NiFe. As shown in FIG. 8A, the case in which CoFe/NiFe is used shows large coercivity, which exceeds the target value of 800 A/m in a certain region of the film thickness. The case in which CoFe/CoFeB/NiFe is used shows a reduction in coercivity, which advantageously remains less than or equal to the target value within the range of the experiment. In particular, it was found that the coercivity is reduced in the range of large film thicknesses. As shown in FIG. 8B, the magnetostriction tends to increase in accordance with an increase in the film thickness of the CoFe layer, but still satisfies the target value when the film thickness is about 1.2 nm, causing no practical problems. Therefore, the film thickness of the CoFe layer in the free layer should desirably be 1.2 nm or less. The minimum film thickness of the CoFe layer should preferably be 0.1 nm or more, taking into consideration film-depositing characteristics.

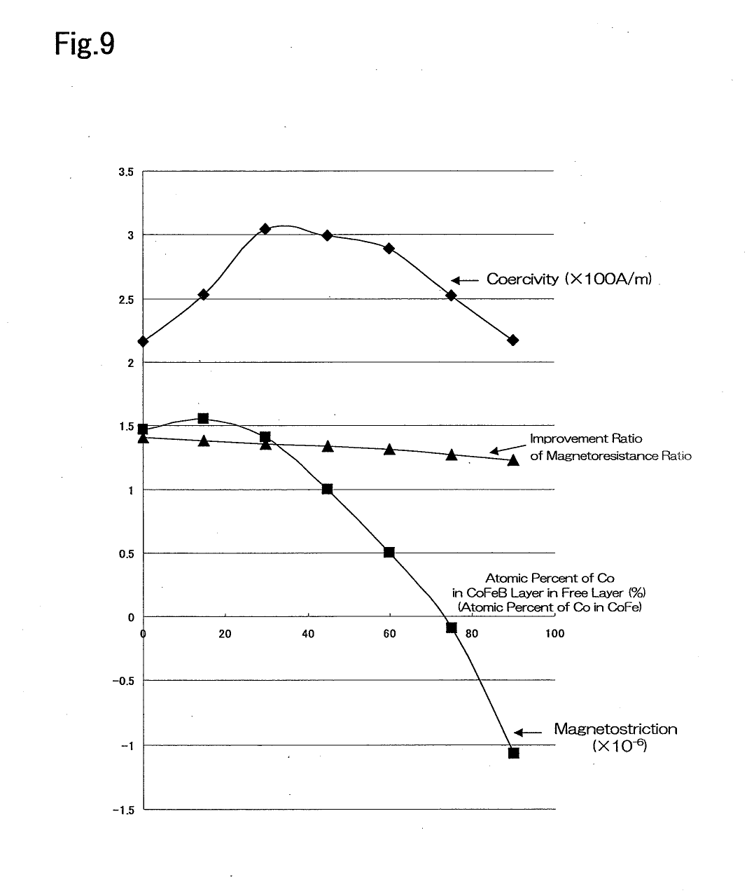

FIG. 9 shows the coercivity, the magnetostriction and the improvement ratio of the magnetoresistance ratio when the concentration (atomic percent) of Co in the CoFeB layer in the free layer was varied. Specifically, the concentrations of B and CoFe in the CoFeB layer were fixed at 18% and at 82%, respectively, and the concentration of Co in CoFe was treated as a parameter. The concentration of Co was defined as the atomic percent of Co in CoFe. As with the case in FIG. 7, the improvement ratio of the magnetoresistance ratio is a value that is normalized by the magnetoresistance ratio in the case in which the film thickness of the CoFeB layer is nil, i.e., the case in which the free layer has the conventional configuration of CoFe/NiFe. The coercivity reaches its maximum when the concentration of Co is near 30%, but is significantly lower than the target value of 800 A/m, causing no problem. The magnetoresistance ratio is more than 1 in the entire range of the Co concentration. The magnetostriction decreases in accordance with an increase in the concentration of Co, but remains in a proper range.

The representative embodiments are described above with regard to the CPP-GMR element having the free layer and the pinned layer and with regard to the TMR element having the free layer and the pinned layer. However, the present invention is also applicable to a magnetoresistance effect element of a novel type that is described above with respect to the conventional art. Specifically, the magnetoresistance effect element according to the present invention may comprise a pair of magnetic layers whose magnetization directions form a relative angle therebetween that is variable depending on an external magnetic field, and may comprise a crystalline spacer layer sandwiched between the pair of magnetic layers, and sense current may flow in a direction that is perpendicular to a film plane of the pair of magnetic layers and the spacer layer. The spacer layer of the magnetoresistance effect element of the above type may be constructed in exactly the same manner as the above embodiments. Either or both magnetic layers whose magnetization direction is variable depending on the external magnetic field has a layer configuration in which a CoFeB layer is sandwiched between a CoFe layer and a NiFe layer and is positioned between the spacer layer and the NiFe layer.

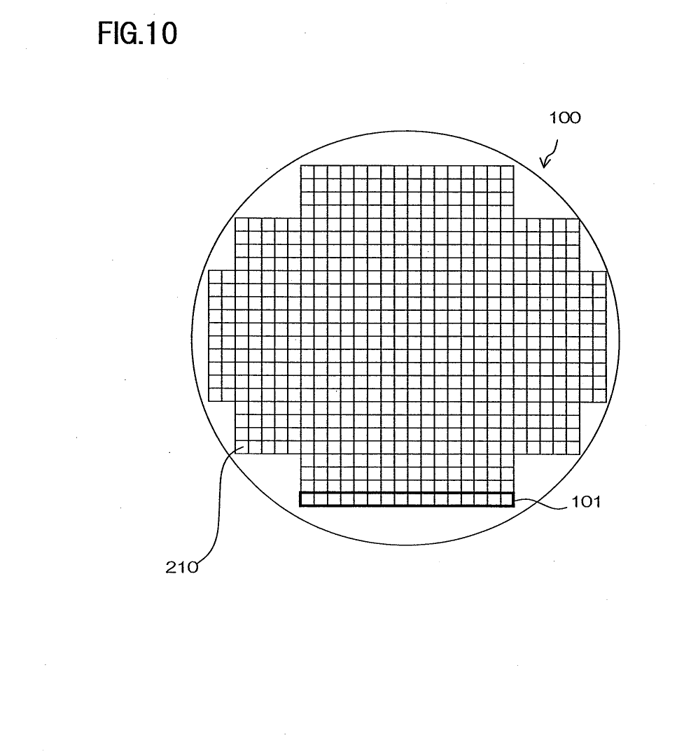

Next, explanation will be made regarding a wafer for fabricating a magnetic field detecting element described above. FIG. 10 is a schematic plan view of a wafer. Wafer 100 has a stack deposited thereon that includes at least magnetic field detecting element 2 described above. Wafer 100 is diced into bars 101 which serve as working units in the process of forming air bearing surface ABS. After lapping, bar 101 is diced into sliders 210 which include thin-film magnetic heads. Dicing portions, not shown, are provided in wafer 100 in order to dice wafer 100 into bars 101 and into sliders 210.

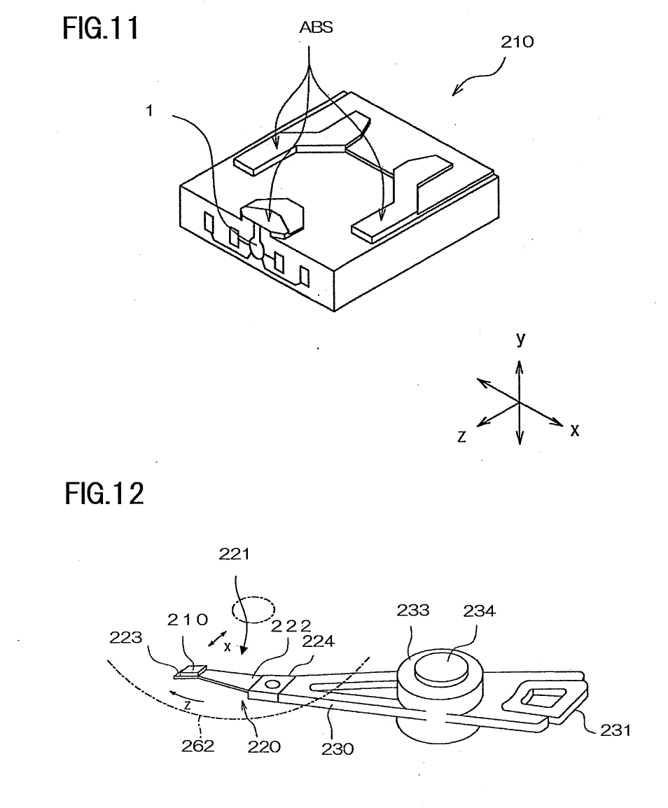

Referring to FIG. 11, slider 210 has a substantially hexahedral shape. One surface out of six the surfaces of slider 210 forms air bearing surface ABS, which is positioned opposite to the hard disk.

Referring to FIG. 12, head gimbal assembly 220 has slider 210 and suspension 221 for resiliently supporting slider 210. Suspension 221 has load beam 222 in the shape of a flat spring and made of, for example, stainless steel, flexure 223 that is attached to one end of load beam 222, and base plate 224 provided on the other end of load beam 222. Slider 210 is fixed to flexure 223 to provide slider 210 with an appropriate degree of freedom. The portion of flexure 223 to which slider 210 is attached has a gimbal section for maintaining slider 210 in a fixed orientation.

Slider 210 is arranged opposite to a hard disk, which is a rotationally-driven disc-shaped storage medium, in a hard disk drive. When the hard disk rotates in the z direction shown in FIG. 12, airflow which passes between the hard disk and slider 210 creates a dynamic lift, which is applied to slider 210 downward in the y direction. Slider 210 is configured to lift up from the surface of the hard disk due to this dynamic lift effect. Thin film magnetic head 1 is formed in proximity to the trailing edge (the end portion at the lower left in FIG. 11) of slider 210, which is on the outlet side of the airflow.

The arrangement in which a head gimbal assembly 220 is attached to arm 230 is called a head arm assembly 221. Arm 230 moves slider 210 in transverse direction x with regard to the track of hard disk 262. One end of arm 230 is attached to base plate 224. Coil 231, which constitutes a part of a voice coil motor, is attached to the other end of arm 230. Bearing section 233 is provided in the intermediate portion of arm 230. Arm 230 is rotatably held by shaft 234 which is attached to bearing section 233. Arm 230 and the voice coil motor to drive arm 230 constitute an actuator.

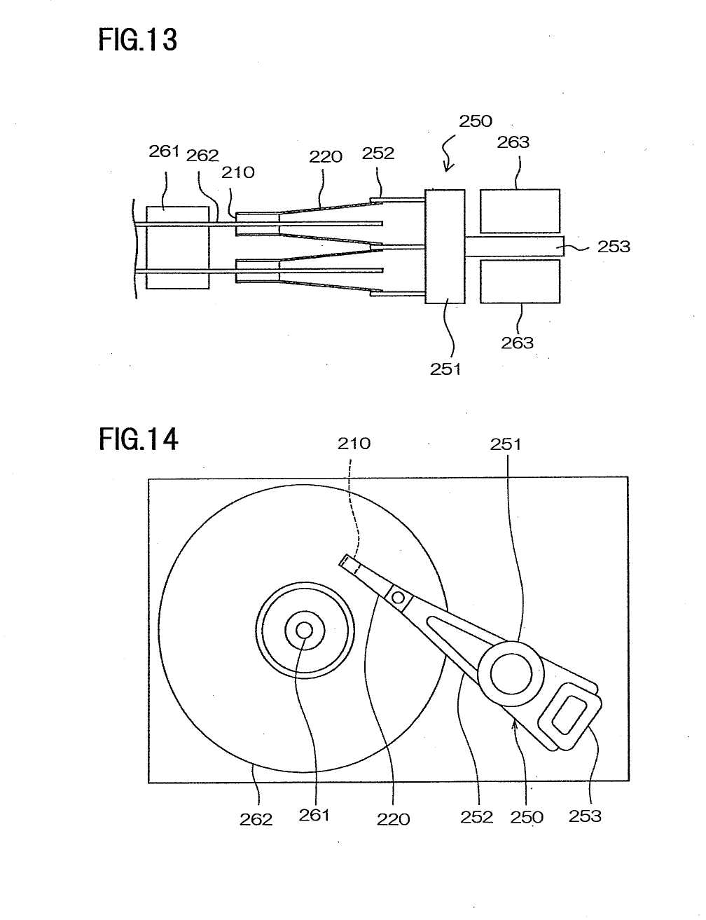

Referring to FIG. 13 and FIG. 14, a head stack assembly and a hard disk drive that incorporate the slider mentioned above will be explained next. The arrangement in which head gimbal assemblies 220 are attached to the respective arm of a carriage having a plurality of arms is called a head stack assembly. FIG. 13 is a side view of a head stack assembly, and FIG. 14 is a plan view of a hard disk drive. Head stack assembly 250 has carriage 251 is provided with a plurality of arms 252. Head gimbal assemblies 220 are attached to arms 252 such that head gimbal assemblies 220 are arranged apart from each other in the vertical direction. Coil 253, which constitutes a part of the voice coil motor, is attached to carriage 251 on the side opposite to arms 252. The voice coil motor has permanent magnets 263 which are arranged in positions that are opposite to each other and interpose coil 253 therebetween.

Referring to FIG. 14, head stack assembly 250 is installed in a hard disk drive. The hard disk drive has a plurality of hard disks which are connected to spindle motor 261. Two sliders 210 are provided per each hard disk 262 at positions which are opposite to each other and interpose hard disk 262 therebetween. Head stack assembly 250 and the actuator, except for sliders 210, work as a positioning device in the present invention. They carry sliders 210 and work to position sliders 210 relative to hard disks 262. Sliders 210 are moved by the actuator in the transverse direction with regard to the tracks of hard disks 262, and positioned relative to hard disks 262. Thin film magnetic head 1 that is included in slider 210 writes information to hard disk 262 by means of the write head portion, and reads information recorded in hard disk 262 by means of the read head portion.

Although a certain preferred embodiments of the present invention have been shown and described in detail, it should be understood that various changes and modifications may be made without departing from the spirit or scope of the appended claims.

What is claimed is:

1. A magnetoresistance effect element comprising:
a pair of magnetic layers whose magnetization directions form a relative angle therebetween that is variable depending on an external magnetic field; and
a crystalline spacer layer sandwiched between said pair of magnetic layers;
wherein sense current may flow in a direction that is perpendicular to a film plane of said pair of magnetic layers and said spacer layer;
wherein said spacer layer includes a crystalline oxide; and
wherein either or both magnetic layers whose magnetization direction is variable depending on the external magnetic field has a layer configuration in which a CoFeB layer is sandwiched between a CoFe layer and a NiFe layer and is positioned between said spacer layer and said NiFe layer.

2. The magnetoresistance effect element according to claim 1, wherein said pair of magnetic layers comprises a pinned layer whose magnetization direction is fixed with respect to the external magnetic field, and a free layer whose magnetization direction is variable depending on the external magnetic field.

3. The magnetoresistance effect element according to claim 1, wherein said spacer layer has a layer configuration in which a ZnO layer is interposed between Cu layers.

4. The magnetoresistance effect element according to claim 3, wherein B in said CoFeB layer has an atomic percent ranging from 6% to 31%.

5. The magnetoresistance effect element according to claim 3, wherein said CoFeB layer has a film thickness ranging from 0.1 nm to 1.0 nm.

6. The magnetoresistance effect element according to claim 1, wherein said spacer layer has a layer configuration in which a ZnO layer is sandwiched between a Cu layer and a Zn layer.

7. The magnetoresistance effect element according to claim 6, wherein Co has an atomic percent ranging from 70% to 90% in CoFe, wherein said CoFe constitutes said CoFeB layer

8. The magnetoresistance effect element according to claim 1, wherein said spacer layer includes an MgO layer.

9. The magnetoresistance effect element according to claim 8, wherein said CoFeB layer has a film thickness ranging from 0.1 nm to 1.0 nm.

10. The magnetoresistance effect element according to claim 8, wherein said CoFe layer has a film thickness ranging from 0.1 nm to 1.2 nm.

11. A thin-film magnetic head that includes a magnetoresistance effect element according to claim 1.

12. A slider comprising:
a stack that includes a magnetoresistance effect element according to claim 1; and
a pair of electrodes that sandwich said stack therebetween, said electrodes adapted to supply the sense current to said stack.

13. A wafer that includes a magnetoresistance effect element according to claim 1, formed therein.

14. A head gimbal assembly comprising:
a slider according to claim 12; and
a suspension resiliently supporting said slider.

15. A hard disk drive comprising:
a slider according to claim 12; and
an element for supporting said slider and for positioning said slider with respect to a recording medium.
